(19) United States
(12) Patent Application Publication
(10) Pub. No.: US 2008/0002672 A1
(43) Pub. Date: Jan. 3, 2008

(54) Method and apparatus for a single chassis communication server with connection-specific interfaces

(75) Inventor: Tzerng-Hong Lin, Milpitas, CA (US)

Correspondence Address: James M. Wu Orion Law Group, Suite 820, 84 West Santa Clara Street, San Jose, CA, 95113, US

(73) Assignee: V2 Technology Inc., Fremont, CA (US)

(21) Appl. No.: 11/823,270

(22) Filed: Jun. 27, 2007

Related U.S. Application Data
(60) Provisional application No. 60/817,501, filed on Jun. 28, 2006.

(51) Int. Cl. H04L 12/66; H04J 1/02; H04M 7/00

(52) U.S. Cl. 370/352; 370/493; 370/494; 379/220.01; 379/90.01; 709/203

(57) ABSTRACT

A method and device for communicating multiple communications networks from a single chassis is disclosed. In an exemplary embodiment, the communication device includes a processing unit, a network interface, a service interface, an endpoint interface, and a cluster interface. The processing unit controls various data flows in the communication device. The network interface communicates to at least one other communications network. The endpoint interface provides communication to local end devices and between local systems. While the service interface is designated to enhance service capabilities, the cluster interface is devised to expand system capacity. In this embodiment, the processing unit, the network interface, the service interface, the endpoint interface, and the cluster interface are assembled in one unit.

### PRIORITY

This application claims the benefit of priority based upon U.S. Provisional Patent Application Ser. No. 60/817,501, filed on Jun. 28, 2006 in the name of the same inventor and entitled “METHOD AND APPARATUS FOR SINGLE CHASSIS COMMUNICATION SERVER WITH CONNECTION-SPECIFIC INTERFACES.”

### FIELD OF THE INVENTION

The embodiments of present invention relates to the field of communications network. More specifically, the embodiments of present invention relate to networking implementation and services for multiple applications.

### BACKGROUND OF THE INVENTION

With increasing demand of data, voice, and video information to be supplied to businesses and/or homes, network communication providers typically channel their information to businesses and/or homes independently. Typical communication systems employ various independent communication units for each application. The independently operated units, for example, include Private Branch EXchange (“PBX”), voice/video/electronic mails, Fax server, digital subscriber line (“xDSL”) modem, Internet Protocol (“IP”) router, Ethernet switch, WiFi access point, conference bridge, Firewall, security alarm, surveillance system, and so on. To operate, integrate, and maintain such independently operated units are complicated. For such independently operated units to communicate with each other, for example, various adapters are typically required to facilitate communications between such units.

Accordingly, there is a need in the art to replace all these units with a single-chassis multiple-application server, which will simplify the installation, administration, and its use.

### SUMMARY OF THE INVENTION

An exemplary embodiment of the present invention discloses a device or a method of communicating with multiple networks from a single chassis communication device. The communication device includes a processing unit, a network interface, a service interface, an endpoint interface, and a cluster interface. The processing unit controls various data flows in the communication device. The network interface communicates to at least one other communications network. The endpoint interface provides communication to local end devices and between local systems. While the service interface is designated to enhance service capabilities, the cluster interface is devised to expand system capacity. In this embodiment, the processing unit, the network interface, the service interface, the endpoint interface, and the cluster interface are assembled in one unit.

Additional features and benefits of the present invention will become apparent from the detailed description, figures and claims set forth below.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only:

FIG. 1A is a block diagram illustrating a communication device capable of connecting multiple endpoints to multiple networks in accordance with one embodiment of the present invention;

FIG. 1B-D are block diagrams illustrating central unit used in the communication device in accordance with one embodiment of the present invention;

FIG. 2 is a block diagram illustrating an example of communication device coupling to WAN/Internet and PSTN for voice communications in accordance with one embodiment of the present invention;

FIG. 3 is a block diagram illustrating an example of communication device coupling to endpoints with WAN/Internet access for data communications in accordance with one embodiment of the present invention;

FIG. 4 is a block diagram illustrating an example of communication device facilitating a video conference system in accordance with one embodiment of the present invention;

FIG. 5 is a block diagram illustrating an example of communication device managing a surveillance system in accordance with one embodiment of the present invention;

FIG. 6 is a block diagram illustrating an example of communication device controlling a voice and video messaging system in accordance with one embodiment of the present invention;

FIG. 7 is a block diagram illustrating an example of communication device connected to other servers via a cluster interface in accordance with one embodiment of the present invention;

FIG. 8 is a block diagram illustrating another configuration using a clustered WAN and LAN connections of communication devices in accordance with one embodiment of the present invention;

FIG. 9 is a block diagram illustrating an example of communication device connected to a central office using a single wire to replace multiple POTS lines in accordance with one embodiment of the present invention;

FIG. 10 is a block diagram illustrating a printed circuit board having a communication device in accordance with one embodiment of the present invention;

FIG. 11 is a flowchart illustrating a process of a communication device in accordance with one embodiment of the present invention; and

FIG. 12 is a flowchart illustrating a process of a communication device with PBX in accordance with one embodiment of the present invention.

### DETAILED DESCRIPTION

Exemplary embodiments of the present invention are described herein in the context of a method, system, and apparatus for communicating with multiple networks from a single chassis. Those of ordinary skill in the art will realize that the following detailed description of the present invention is illustrative only and is not intended to be in any way limiting. Other embodiments of the present invention will readily suggest themselves to such skilled persons having the benefit of this disclosure. It will be apparent to one skilled in the art that these specific details may not be required to practice the embodiments of the present invention. In other instances, well-known circuits and devices are shown in block diagram form to avoid obscuring the present invention. In the following description of the embodiments, substantially the same parts are denoted by the same reference numerals.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

It is understood that the present invention may contain transistor circuits that are readily manufacturable using well-known art, such as for example CMOS (“complementary metal-oxide semiconductor”) technology, or other semiconductor manufacturing processes. In addition, the present invention may be implemented with other manufacturing processes for making digital devices.

An exemplary embodiment of the present invention discloses a communication device or system used for communicating with multiple networks from a single chassis. The communication device includes a processing unit, a network interface, a service interface, an endpoint interface, and a cluster interface. The processing unit controls various data flows in the communication device. The network interface communicates to at least one other communications network. The endpoint interface provides communication to local end devices and between local systems. While the service interface is designated to enhance service capabilities, the cluster interface is devised to expand system capacity. In this embodiment, the processing unit, the network interface, the service interface, the endpoint interface, and the cluster interface are assembled in one unit.

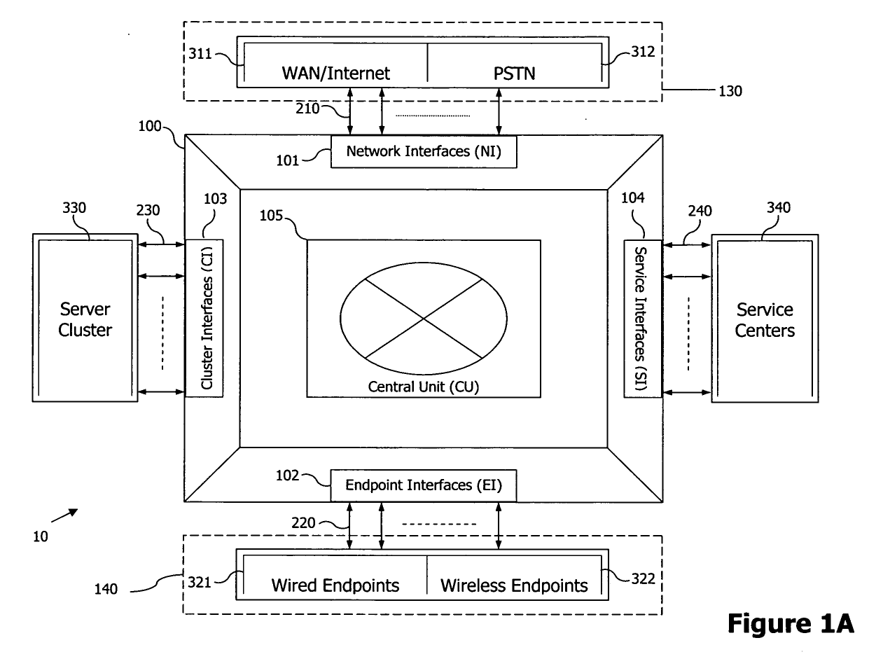

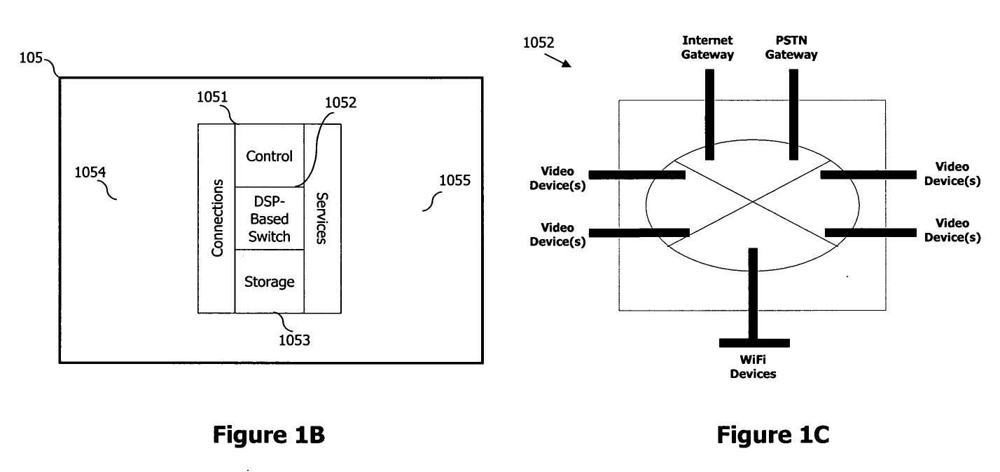

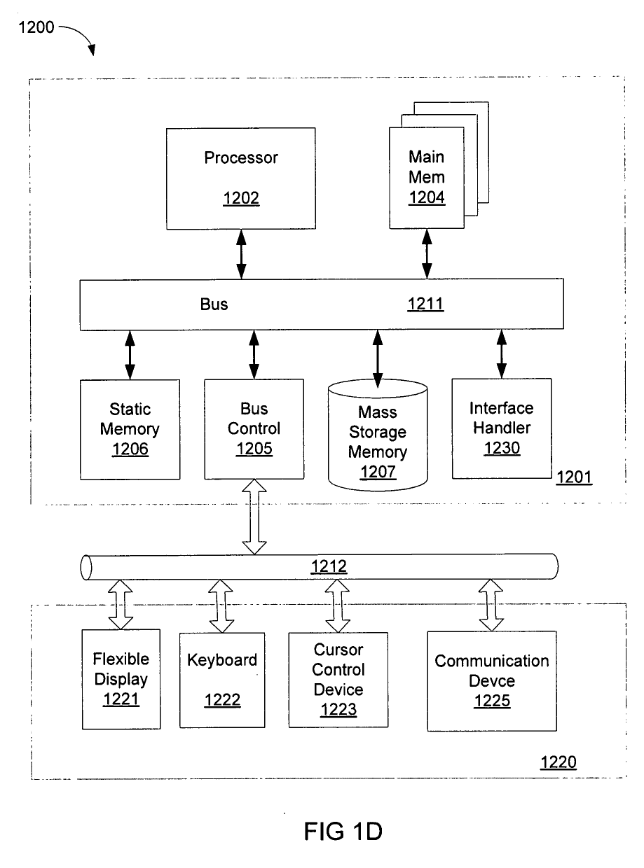

FIG. 1A is a block diagram 10 illustrating a communication server or device 100, which is capable of communicating with multiple networks in accordance with one embodiment of the present invention. Diagram 10 further includes a communications network(s) 130, service centers 340, various endpoint devices 140, and a cluster of servers 330. It should be noted that the underlying concept of the present invention would not change if one or more devices or systems were added to diagram 10.

Communication device 100, shown in FIG. 1A, in one embodiment, is constructed in a single chassis that includes a central unit (“CU”) 105 and four (4) groups of interfaces, which are-network interface (“NI”) 101, endpoint interface (“EI”) 102, cluster interface (“CI”) 103, and service interface (“SI”) 104. It should be noted that communication device 100 may include interfaces, such as a dedicated local area network (“LAN”) interface or a short-range communication (i.e., blue tooth, HDMI, and so on) interface or a global positioning system (“GPS”) interface, in one of the four interface groups as well. It should be noted that the term “communication device 100” and “communication server 100” are referenced through out this application for the same or substantially the same device.

CU 105, which may also be known as a processing unit, a microprocessor, a digital processor, a controller, a central processing unit, a cluster of processors, and so on, is used to manage and control the data flows between the interfaces. CU 105 is, for example, a high throughput low-latency Quality of Services (“QoS”) enabled packet switching core with dynamic session control and embedded call management for voice, video, and data exchange.

NI 101, EI 102, CI 103, and SI 104, in one embodiment, are four groups of connection-specific interfaces wherein each group of the interfaces may include connections to Ethernet, digital subscriber line (“DSL”), WiFi/WiMax, 3G/4G, FXO/FXS, integrated services digital network (“ISDN”), T1/E1, T3/E3, OC-1/OC-3, universal serial bus (“USB”), universal asynchronous receiver/transmitter (“UART”), FireWire(“IEEE 1394”), and/or other physical links. Each group of the interfaces is further configured to have its own pre-defined connectivity mechanism and applications. For example, NI 101 is used to interface with wide area network (“WAN”)/Internet 311 and/or public switched telephone network (“PSTN”) 312 for uploading or downloading data, voice, and/or video information via wired or wireless links 210.

EI 102, in one embodiment, is used to connect to wired endpoints 321 and/or wireless endpoints 322 via wired or wireless links 220 directly or indirectly. Endpoints 321-322 includes various electronic devices, such as Ethernet hubs/switches, personal computers (“PCs”), personal digital assistants (“PDAs”), plain old telephone service (“POTS”) phones, ISDN phones, WiFi/IP phones, video phones, video conference terminals, operator consoles, Webcams, surveillance consoles, internet protocol (“IP”)/cell handsets, Skype devices, network storages, network printers, fax machines, or the like.

_CI 103 enables communication device 100 to couple to other servers or systems having similar capabilities as communication devices 100 via links 230 to expand system's capacity. Multiple communication devices 100 can be linked by connections to form a large clustered system, which is capable of supporting more users and processing more data. For example, clustering two communication devices 100 together through IC 103 can double its service capacity. It should be noted that different communication servers may be clustered together using a compatible cluster protocols. A clustered system, in one embodiment, includes multiple communication devices or servers 100 linked by connections. It should be noted that some communication devices 100 in the clustered system are located remotely, and some servers reside at different geographical locations or sites can also be clustered into one single large capacity system.

SI 104, in one embodiment, is capable of coupling to various different service providers, such as telephone companies, Internet service providers, application service providers, security service providers, utility companies, public safety answering points, network management center, even special recording systems, and/or other server machines. In one example, SI 104 is used to interface with emergency equipments and security monitors using links 240. Links 240 can be wired connections, wireless connections, or a combination of wired and wireless connections. In another example, SI 104 is used to interface with utility devices, directory servers, storage devices, network management system, and/or other service centers/equipments 340. By linking communication device 100 to service resources through SI 104, the information relating to area surveillance and intrusion alert, for example, can be automatically sent to a security company for any triggering events. The surveillance video triggered by alert events, for instance, can be stored to a video recorder attached to SI for future reference. In another example, utility records can be forwarded directly to utility company on a periodical basis via SI 104. The monitoring, managing, and maintaining communication device 100, in one embodiment, can be performed remotely via SI 104. In another embodiment, emergency calls can be routed to a public safety answering point along with the location information.

During operation, information exchange between voice, data, video, and a combination of voice, video, and data between different interfaces is processed and performed by CU 105. It should be noted that terms “data” and “information” are used interchangeable herein. CU 105, for example, acts as an all-in-one exchange unit that is coupled to various different communications networks for transmitting information relating to voice, video, and data. All these voice and video streams are given higher priority to meet the QoS requirements and they can be mixed with data packets during the packet delivery. For example, a multiple-party conference call can be handled through a built-in call manager. A voice telephone call, which is initiated by an endpoint device 321 or 322, can be routed to another endpoint device connected through PSTN 312 or WAN/Internet 311 via 210 or to another clustered server via 230. Also, a telephone call will not be routed to service center 340 via SI 104 except in some special cases. For example, emergency or other special calls can be routed to service center 340 through SI 104 for special emergency handlings such as 911 calls.

FIG. 1B is a block diagram illustrating a central unit 105 used in communication device 100, shown in FIG. 1A, in accordance with one embodiment of the present invention. CU 105 includes a call control unit 1051, DSP-based voice/data/video switch core 1052, configuration/messaging storage 1053, connection management 1054, and service management 1055. Call control unit 1051, in one embodiment, is devised to handle various types of calls and/or Voice over IP (“VoIP”) calls from various communications networks. Service management 1055 is devised to control SI 104, while connection management 1054 is devised to manage CI 103. It should be noted that one of ordinary skilled in the art that other functional blocks may be added to CU 105.

It should be noted that CU 105 is capable of receiving information from multiple communications networks such as Internet, wireless networks, and cables, and subsequently, redistributing received information to various interfaces such as NI 101, EI 102, CI 103, and SI 104.

FIG. 1C is block diagram illustrating a DSP 1052, as shown in FIG. 1B, in CU 105 in communication device 100, shown in FIG. 1A, in accordance with one embodiment of the present invention. A digital signal processing (“DSP”), in one embodiment, is used to increase its video performance. DSP 1052, for example, can be a high bandwidth DSP packet switch core with multiple video input channels and video output channels. DSP 1052 is further devised to directly couple to WiFi devices, PSTN gateway, and Internet gateway. In another embodiment, multiple DSPs 1052 are used to enhance the video computing capacity. For example, DSP 1052 is capable of processing video enabled packet switch having a capacity of six (6) gigabits per second with QoS and bandwidth control. Also, DSP 1052 supports non-blocking traffic with no packet collisions and has built-in call manager that supports voice/video/data calls. A data call is a “VPN with QoS” session that transmits data packets meeting specific bandwidth requirements, such as minimum/maximum guaranteed bandwidth etc.

The exemplary embodiments of the present invention select and integrate a subset of communication mechanisms in a single chassis system, which provides a solution for desired communication services and applications for an entity. The single chassis server or communication device 100, shown in FIG. 1A, works as a private branch exchange (“PBX”) with built-in soft switch, a wired and/or wireless LAN with WAN/Internet access, a surveillance system with security connection and control, a video exchange with conference bridges, a Firewall with Anti-virus/Anti-worm and content/connection filtering, a Web server, a voice/video/electronic mail server, a Fax server, and a network storage management system. In other words, an integrated access system (IAS) uses a single chassis server in one box to provide PBX, VoIP gateway, Internet access, wired and wireless LAN, Fax, voice/video/electronic mails, voice/video conference bridges, collaboration control, electronic training, video surveillance, utility report generator, and other communication services. A complete set of call management and network security features (such as auto attendant, automatic call distribution, workgroup, operator console, automatic VoIP/PSTN call routing, directory service, VPN, Firewall, Anti-virus/Anti-worm, call filtering, content filtering, and connection screening) will also be integrated.

An advantage of the exemplary embodiments of the present invention is to make a single box system fulfilling multiple communications and security needs for an organization or entity. Another advantage is the clustering feature that expands system's capacity and is capable of linking remote branch offices' systems. A purpose of the exemplary embodiments of the present invention is to consolidate various communications into one single box system to reduce the hardware cost and operation expense and to simplify installation, administration, and applications. For instance, communication device 100, shown in FIG. 1A, may be used to replace small or medium PBX, LAN, and video surveillance system; and communication device 100 should provide most of the required communication services for a small to medium business (SMB). The target of applications is one box (chassis) for all communications needs to small to midsize companies.

Another advantage of “one box for all” design is a solution for “all-in-one” applications to fulfill necessary communications as well as security needs. Considering the capacity of large enterprises and multi-site environment, the “one box for all” concept can be implemented and applied to every organizational level. The clustering feature allows users to expand or to reduce system capacity according to their needs. To meet the multi-site and large capacity applications, for example, a clustered system with multiple communication devices 100 linked by inter-connections may be used. In another embodiment, the inter-company communications can be achieved via either public networks (such as Internet and PSTN) or a fast dedicated WAN while the security and network management can be connected through various service links.

Having briefly described exemplary embodiments of communication device 100, shown in FIG. 1A, in which the present invention operates, FIG. 1D illustrates a data processing system 1200, which may be used as communication device 100 in accordance with one embodiment of the present invention. Computer system 1200 includes a processing unit 1201, an interface bus 1211, and an input/output (“10”) unit 1220. Processing unit 1201, which could be CU 105, includes a processor 1202, a main memory 1204, a system bus 1211, a static memory device 1206, a bus control unit 1205, a mass storage memory 1207, and interface handler 1230. Bus 1211 is used to transmit information between various components and processor 1202 for data processing. Processor 1202 may be any of a wide variety of general-purpose processors or microprocessors such as Pentium™ microprocessor, Motorola™ 68040, or Power PC™ microprocessor. Interface handler 1230 is configured to communicate with NI 101, SI 104, EI 102, and CI 103.

Main memory 1204, which may include multiple levels of cache memories, stores frequently used data and instructions. Main memory 1204 may be RAM (random access memory), MRAM (magnetic RAM), or flash memory. Static memory 1206 may be a ROM (read-only memory), which is coupled to bus 1211, for storing static information and/or instructions. Bus control unit 205 is coupled to buses 1211-1212 and controls which component, such as main memory 1204 or processor 1202, can use the bus. Bus control unit 1205 manages the communications between bus 1211 and bus 12l2. Mass storage memory 1207, which may be a magnetic disk, an optical disk, hard disk drive, floppy disk, CD-ROM, and/or flash memories for storing large amounts of data.

I/O unit 1220, in one embodiment, includes a display 1221, keyboard 1222, cursor control device 1223, and communication device 1225. Keyboard 1222 may be a conventional alphanumeric input device for communicating information between computer system 1200 and computer operator(s). Another type of user input device is cursor control device 1223, such as a conventional mouse, touch mouse, trackball, a finger or other type of cursor for communicating information between system 1200 and user(s). Communication device 1225 is coupled to bus 1211 for accessing information from remote computers or servers, such as server 104 or other computers, through wide-area network. Communication device 1225 may include a modem or a wireless network interface device, or other similar devices that facilitate communication between computer 1200 and the network.

Exemplary embodiment of the present invention integrates different communication functions into a single box to reduce the complexity of system. Because the single box with various connectivity features capable of communicating with various networks, communication device 100, shown in FIG. 1 A, with a single box is easier to maintain and operate. With a clustering feature, multiple boxes can be linked locally or via WAN to form a large distributed system for big organization and multi-site applications. The advantage of this design is simplicity, low cost, fast installation, and easy to use.

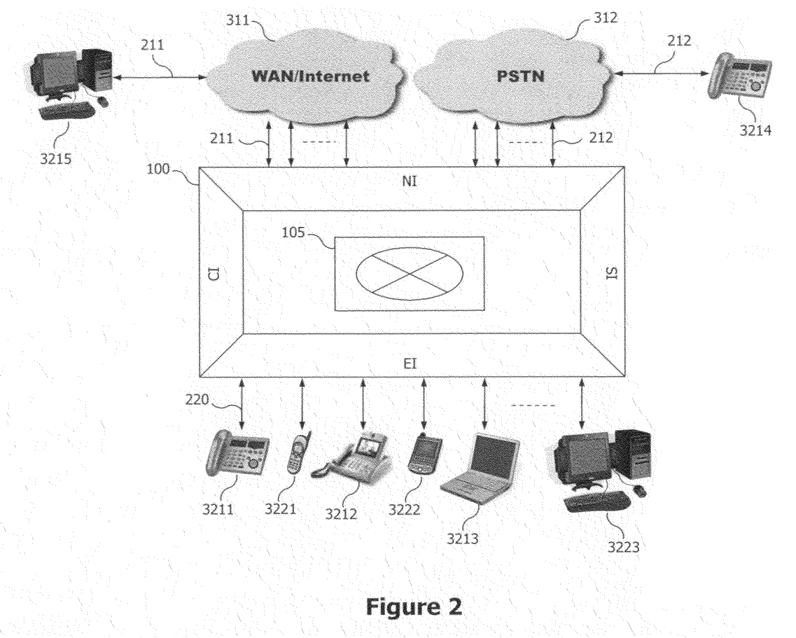

FIG. 2 is a block diagram illustrating an example of communication device 100 coupling to WAN/Internet 311 and PSTN 312 in accordance with one embodiment of the present invention. When communication device or server 100, as shown in FIG. 1A, is coupled to PSTN 312 with voice endpoints such as telephone 3211, WiFi handset 3221, video phone 3212, WiFi soft phone on PDA 3222, laptop computer 3213, and video conference terminal 3223, communication device 100 is capable of performing PBX functions plus additional video exchange capabilities. For example, communication device 100 is capable of establishing connections between telephone devices and maintaining the connection until the connection is no longer needed. Communication device 100 may provide other PBX functions such as call transfer, call waiting, call forwarding, conference call, hunt group, workgroup, voice mail, and so on.

Communication device 100, as shown in FIG. 1A, in one embodiment, is connected to WAN/Internet 311 to provide voice over IP and video over IP related features. CU 105, in this embodiment, provides a per session dynamic channel allocation with per session QoS for voice and video calls and video conference sessions. For outgoing call, one of the endpoints 3211-3223, for example, initiates a call by registering the outgoing destination address (a phone number, an IP address, or a selected entry in a directory) first, and then sends the destination address to CU 105 for call setup. Control processor 1051 in CU 105, as shown in FIG. 1B, looks up a table in its storage 1053 to determine how the call should be routed to the destination. The outgoing call will then be set up with one of endpoints 3211-3223 connecting to EI 102 and routed to a remote endpoints 3214 or 3215 connecting to WAN/Internet 311 or PSTN 312, respectively.

For incoming call, one of the interfaces in NI 101 group, for example, passes an incoming signal to CU 105 for call handling. CU 105 then inquires the destination address from the calling party or a call routing server in network 311 or 312. Upon receipt of the information from network 311 or 312, CU 105 connects the incoming call to one of the endpoints 3211-3223 to complete the call setup process. During the call sessions, all voice and/or video signals are digitized into digit streams and packed into data packets for transmission. DSP-based switch 1052, as shown in FIG. 1B, in CU 105 serves as an exchange with video telephony processor (and/or FAX transceiver) that delivers data packets to destinations in a timely fashion. DSP 1052 is also capable of providing voice/image processing resources as well as conference bridges for multi-party heterogeneous video conference and FAX call sessions. It should be noted that packet exchanges are regulated with channel-based session QoS to ensure the correct data rate and minimal delay to guaranty the quality of calls.

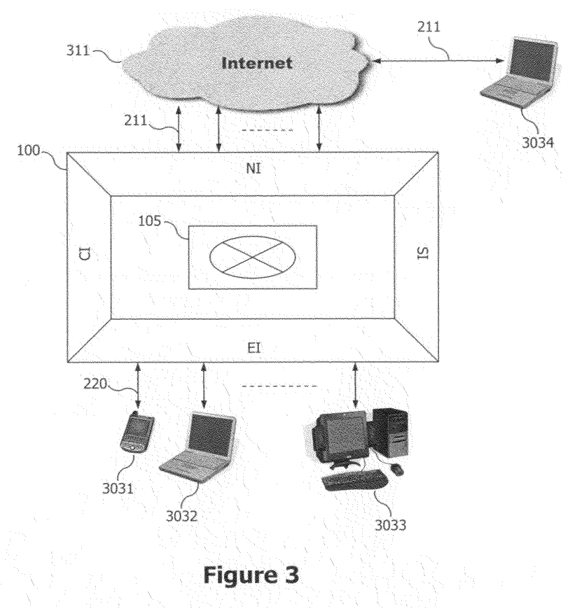

FIG. 3 is a block diagram illustrating an example of communication device I 00 coupling to endpoints with WAN/Internet in accordance with one embodiment of the present invention. Communication device 100, as shown in FIG. 1A, is connected to WAN/Internet 311 via a group of data links 211, wherein data links 211 can be wired cables or wireless networks. FIG. 3 illustrates communication device 100 as a single-point data access equipment with a built-in packet switching and data routing feature, wherein device 100 is configured to facilitate connections between endpoints 3031-3033 and WAN/Internet 311.

The local endpoints can be a wireless PDA 3031, a wired or wireless notebook PC 3032, a wired or wireless desktop PC 3033, and/or other data communication equipment. An outside data endpoint 3034 can also connect to communication device 100 by VPN via Internet 311 with a bandwidth guarantied QoS for accesses in a pre-defined data rate. Data accesses between endpoint 3034 and one of the local endpoints 3031-3033 can be mixed with voice and video data streams since DSP 1052 is devised to provide QoS for real-time applications. Communication device or server 100, as shown in FIG. 1A, in one embodiment, passively distributes data, voice, and video information through packets processed by DSP 1052. Call control system 105 1, as shown in FIG. 1B, directs voice and video data using call-setup function to connect endpoint 3034 with one of local endpoints 3031-3033. DSP 1052 also sets up the QoS between endpoint 3034 and local endpoints 3031-3033 by allocating required bandwidth for a predefined call session. It should be noted that the above described process achieves PBX plus Private Data Network in a single configuration.

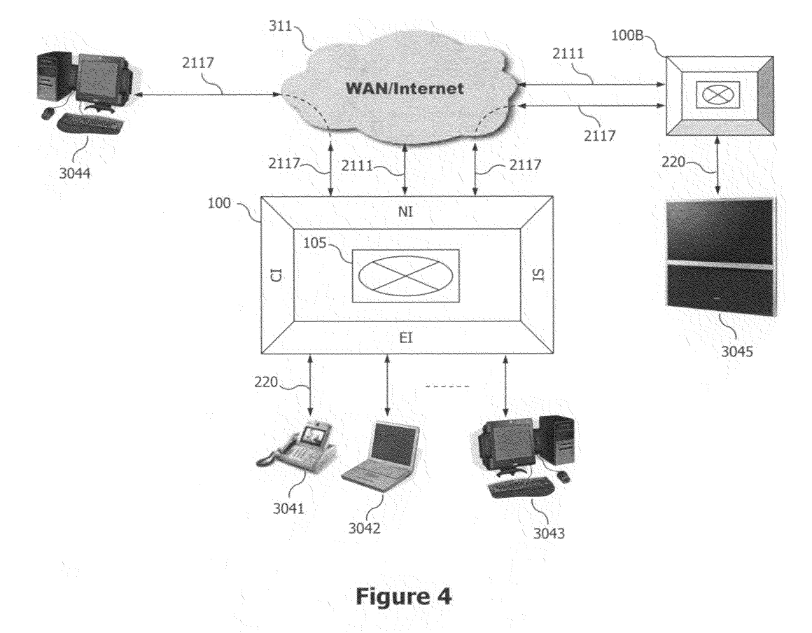

FIG. 4 is a block diagram illustrating an example of communication device 100 facilitating a video conference system in accordance with one embodiment of the present invention. In this example, communication device 100, as shown in FIG. 1A, is configured to provide conference bridges for both voice and video applications. A voice and/or video conference can be initiated by either an active call or a pre-scheduled “meet-me” conference task. Referring back to FIG. 4, video endpoints can be a video IP phone 3041, a soft video phone 3042, a video conference terminal 3044, a video display system 3045, and/or other video communication devices. Video endpoints 3041-3045 are connected to communication device 100 via wired or wireless links 220, wherein links 220 can be wired or wireless connections, such as xDSL, Ethernet, ISDN, T1/E1, USB, FireWire, UART, and/or WiFi/WiMAX.

Referring back to FIG. 4, while the local endpoints 3041-3043 use high frame rate video streams, the remote endpoints 3044-3045 may operate at a reduced frame size/rate video stream if the available bandwidth is limited by the low speed data link 2111. Alternatively, if links 2117, which are used to couple to communication device 100, as shown in FIG. 1A, to remote endpoints 3044-3045, are high bandwidth links, such as T1/E1/T3/E3/OC1/OC3, Frame Relay, or VLAN, endpoints 3044-3045 can still operate at higher frame rate and larger frame size. The conference bridge operated by communication device 100 is capable of adapting different codes, frame sizes, and frame rates from different endpoints. A remote endpoint 3044, for example, can connect to WAN/Internet 311 directly. Alternatively, remote endpoint 3044 may connect to another server 100B, which is further connected to WAN/Internet 311 via either data links 2111 or other lease lines 2117. A conference bridge console or control manager 3043, connected to EI 102, sets up a conference call and monitors the progress of the conference call. It should be noted that the video conference terminal 3044 can also be a soft video phone or a browser-based video phone.

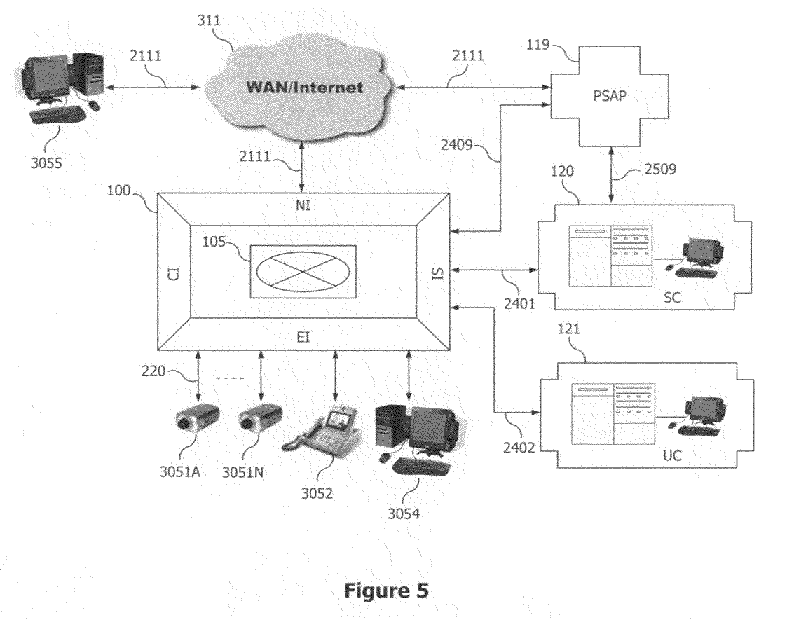

FIG. 5 is a block diagram illustrating an example of a communication device managing a surveillance system in accordance with one embodiment of the present invention. Communication device 100, as shown in FIG. 1A, is used with a video surveillance system through security service. FIG. 5 illustrates a logical diagram including a public safety answering point (“PSAP”) 119, a security company (“SC”) 120, a utility company (“UC”) 121, multiple webcams 3051A to 3051N, and a communication device 100. PSAP 119, SC 120, UC 121, webcams 3051A to 3051N, and communication device 100 are interconnected via links 220 and 2401-2409.

Webcams 305 1A to 305 IN, in one embodiment, are installed in different locations inside a building and are coupled to communication device 100 via EI 102. The video streams generated by these webcams 3051A to 3051N are delivered to a video phone 3052 or a surveillance console 3054, which is locally connected to communication device 100. Alternatively, the video streams can be delivered to a remote browser based surveillance console 3055 connected through WAN/Internet 311. An embodiment of the present invention integrates access server in a house with a wide range of communication and security features for Small to Medium-sized Business (“SMB”) applications.

If one of webcams 305 IA to 305 IN detects an intrusion or fire, it reports the detection to CU 105. The senser/detector subsequently generates an alert signal and sends the alert to all surveillance endpoints 3052, 3054, 3055 if they are logged in the system. In one embodiment, the alert or alert event is sent to SC 120 via link 2401. The staffs at SC 120 can login the system to verify the event through the surveillance system using webcams 305 1A to 305 IN. If an intrusion is verified (i.e., visual confirmation), SC 120 forwards the alert information to PSAP 119 reporting the incident. The staffs at PSAP 119 can further verify the event by logging in the system via WAN/Internet 311 to obtain visual confirmation while security officers are dispatched. In case of a fire alarm, the staff at SC 120 can log in the system and instruct system to turn off gas and electrical supply, and to turn on water sprinkles to distinguish the fire. In an alternative application, if UC 121 is connected to gas, water, and/or electricity meters in a business premise, UC 121 can periodically obtain readings from the meters via SI 103 using link 2402.

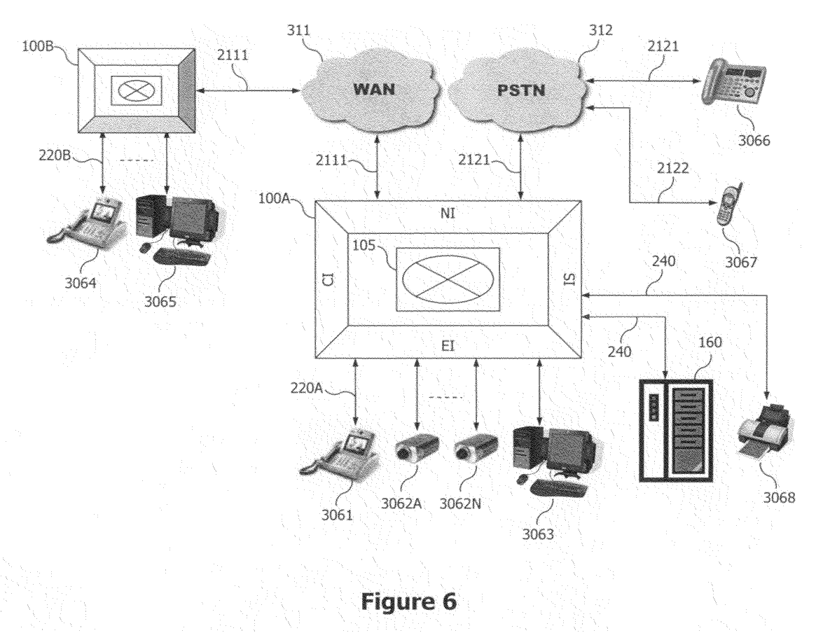

FIG. 6 is a block diagram illustrating an example of a communication device controlling a voice and video messaging system in accordance with one embodiment of the present invention. When an incoming call from an endpoint 3064 or 3066 or 3067 via network 311 or 312 is received, the incoming call can be greeted by a video auto attendant or an audio auto attendant. If the receiving party is not available to pick up the call, the caller can leave a voice and/or video message. In one embodiment, a high capacity recording system 160, which is coupled to communication device 100, shown in FIG. 1A, via links 240, is used to store the high volume video/voice messages. The similar recording system 160 can be used to record surveillance video streams generated by webcams 3062A to 3062N.

System administrator can retrieve and playback the recorded video and voice messages through various devices such as local video phone 3061, surveillance console 3063, remote video phone 3064, remote soft video phone 3065, and the like. The video/audio auto attendant, in one example, is also capable of routing incoming calls to interactive video/voice response (IVR) handlers. The recording system 160 can alternatively be a regular or specialized server, or be various different service equipments connected to SI 104. Communication device 100, shown in FIG. 1A, may use more powerful and sophisticated video/voice mail server or IVR server to handle large volume of data. For incoming FAX calls, communication device 100, for example, operates as FAX server capable of receiving facsimiles from both WAN/Internet 311 and PSTN 312. The received facsimiles can subsequently be either stored in a spooler queue of a spooling system or to server 160 or be printed directly to a printer 3068 connected to SI 104. It should be noted that server 160 connected via SI 104 can be an advanced network management system that monitors, diagnoses, trouble-shoots, and update software for the entire customer private data/video/voice access network and the connected endpoints.

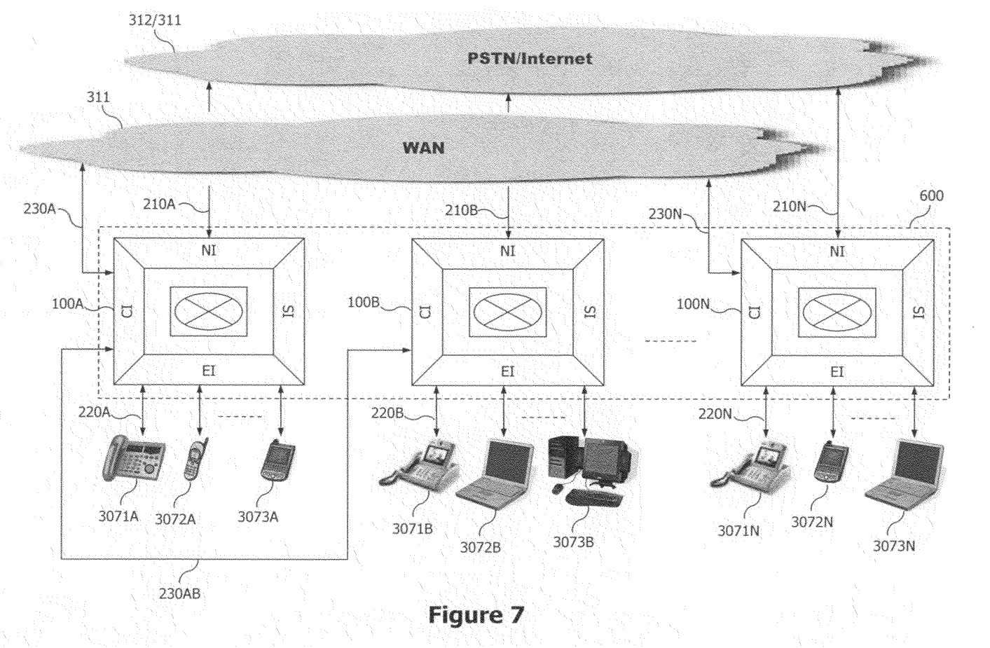

FIG. 7 is a block diagram illustrating an example of communication device 100, shown in FIG. 1A, connected to other servers via a cluster interface in accordance with one embodiment of the present invention. Diagram shown in FIG. 7 illustrates a clustered communication system having multiple similar communication devices 100A-100N. It should be noted that scalability is critical for small to medium businesses because of the growing potential for the companies. As such, for the future growth, good communication systems shall be designed with flexibility for future expansion.

In order to provide capacity multiplication (or expansion), communication device 100, shown in FIG. 1A, has a group of cluster interfaces (CI) 103, as shown in FIG. 1A, to combine several servers into one clustered system 600 as illustrated in FIG. 7. Servers 100A-100N can be locally linked by a group of data links 230A-230N using communication protocols such as Ethernet, xDSL, ISDN, T1/E1, T3/E3, OC1/OC3, and/or WiFi/WiMAX. Alternatively, some or all of servers 100A-100N can be remotely coupled through WAN 311 via links 230A-230N using Ethernet, xDSL, T1/E1, T3/E3, OC1/OC3, 3G/4G, WiFi/WiMAX or the like. Once servers 100A-100N are clustered as a single system, all NI interfaces will work as one NI group and all EI interfaces will work as one El group with the exception of location-specific call routing schemes. In one aspect, clustered system 600 takes the advantage of VoIP feature and automatically route outgoing calls through CI to NI interface for least-cost connection.

For example, when endpoint 3071A on system 100A calls another endpoint 3071N on a remote system 100N, the call setup for a remote system is similar to the call setup for a local endpoint 3072A. When an incoming call from PSTN/Internet 312/311 via link 210A requests a connection to endpoint 3072N on system 100N in a remote branch office, the call will be routed to endpoint 3072N through WAN 311 via links 230A and 230N as if the destination is local to system 100A. Besides the regular PSTN and VoIP calls, emergency calls will be treated with highest priority and routed to local PSAP via local SI for quick response.

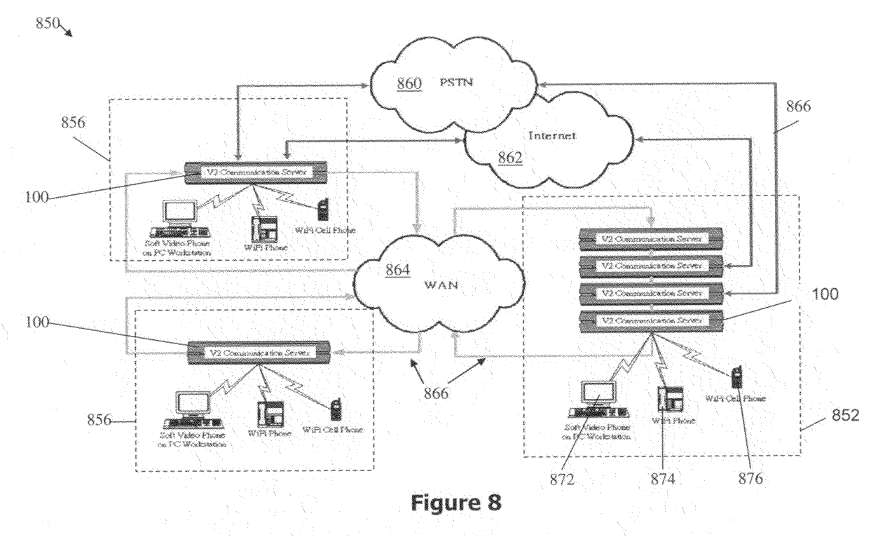

FIG. 8 is a block diagram 850 illustrating another configuration using a cluster of communication devices in accordance with one embodiment of the present invention. Diagram 850 illustrates multiple sites 852-856, Internet 862, PSTN 860, WAN 864, and multiple connections 866. Sites 852-856 can be company locations, business sites, institution facilities, private homes, or the like. It should be noted that the underlying concept of the present invention would not change if one or more devices or systems were added to diagram 850.

Referring back to FIG. 8, each one of sites 852-856 includes at least one communication device 100, as shown in FIG. 1A, which is further capable of coupling with a PC workstation 872, a phone 874, and a cell phone 876. While sites 854-856 includes similar devices, site 852 installs multiple communication devices 100 that they are locally interconnected via cluster interfaces. In one embodiment, communication devices 100 in sites 852-856 are clustered via multiple communications networks, such as WAN 864, PSTN 860, and Internet 862. Various different connections or links 866 using various different network protocols, such as Ethernet, xDSL, ISDN, T1/E1, T3/E3, OC1/OC3, and/or WiFi/WiMAX are used for the connections.

For example, communication devices 100 located in site 852 are clustered with communication device 100 in site 854 using WAN 864, while communication devices 100 located in site 852 are clustered with communication device 100 in site 856 using WAN 864, PSTN 860 and Internet 862. Also, communication device 100 in site 854 is clustered with communication device 100 in site 856 using WAN 864. In one embodiment, any communication devices 100 can be clustered or removed from a clustered system depending on the capacity requirements. It should be noted that more sites can be added or removed over time.

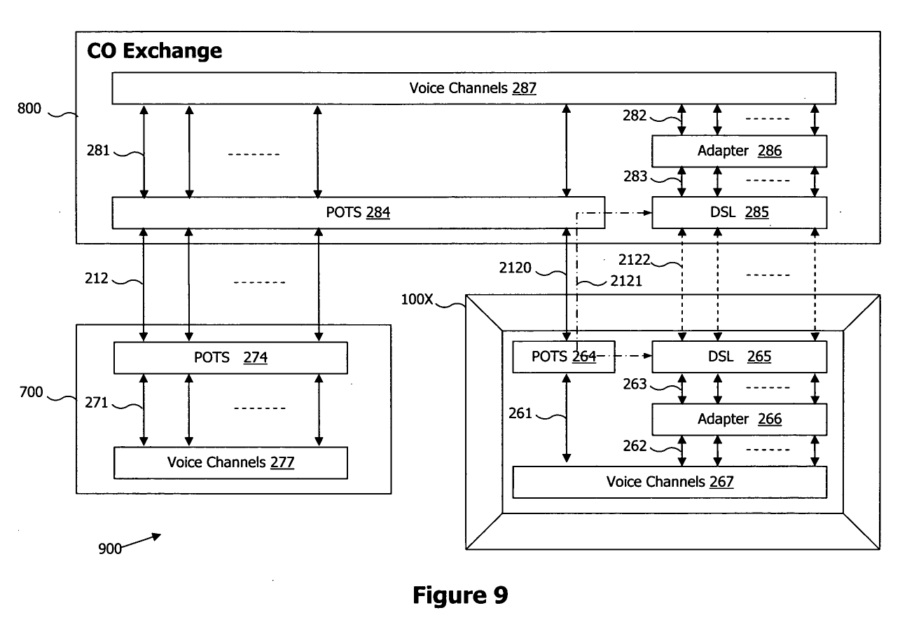

FIG. 9 is a block diagram 900 illustrating a comparison of communication by single pair of POTS wires from a communication device to a central office and by multiple pairs of POTS wires from a PBX 700 to a central office in accordance with one embodiment of the present invention. The single POTS line 2120 in devised with virtual POTS lines 2122 via DSL connection 2121 achieves the same trunk capacity as provided by the multiple POTS lines 212 design. Diagram 900 shows a communication device, a central office (“CO”) Exchange 800, and PBX 700. Communication device 100X, which is similar to communication device 100 shown in FIG. 1A, and CO exchange 800 are coupled via connections 2120-2122 while CO exchange 800 is coupled to PBX 700 via connections 212. It should be noted that the underlying concept of the present invention would not change if one or more devices or systems were added to diagram 900.

Communication device 100X, in one embodiment, is configured to couple to CO Exchange 800 using a DSL link. DSL, also known as xDSL, is capable of providing digital data transmission over a set of telephone wires from a telephone network. Conventional DSL transmission speed can range anywhere from 256 kilobits per second (kbit/s) to 24,000 kbit/s, depending on DSL technology and service implementation. In operation, the POTS line 2120 splits into a low frequency band and a high frequency band wherein the low frequency band is used for telephonic voice transmission while the high frequency band is used for DSL data transmission. The high frequency band, in this application, can be further divided into multiple voice channels and other data pipes. The high and low frequency bands are two independent communication paths, which allow both bands to provide transmissions simultaneously.

Referring back to FIG. 9, Communication device 100X includes a POTS interface 264, a DSLtrunk interface 265, a voice to DSL Adapter 266, and multiple Voice Channels 267, wherein link 261 are used to connect one of the voice channels 267 to POTS interface 264. Also, links 262 are used to connect multiple of the voice channels 267 to adapter 266, while links 263 are used to link adapter 266 to DSL trunk 265. Coupled together with the reverse setup of DSL trunk 285 and DSL to voice Adapter 286 on the CO 800 side, the multiple trunk mechanism can thus be realized so as to provide the same multiple POTS trunk 212 capacity as the PBX 700 has. It should be noted that communication device 100X can contain additional functional blocks as described in FIG. 1A.

POTS component 264, in this embodiment, is used to handle analog voice signals received from telephone companies. POTS relates to voice-grade telephone service that provides telephone services to residential and business premises via telephone network(s) such as PSTN. During the operation, POTS link 262 receives and/or transmits information over the voice band or low frequency band of a DSL line while DSL trunk 265 receives or transmits information between communication device 100X and CO Exchange 800 using the data band or the high frequency band of the DSL line. Adapter 266 receives information from DSL trunk 265 and subsequently passes information to voice channels 267 after the information is converted. Similarly, adapter 266 obtains information from voice channels 267 and then forwards the information to DSL trunk 265 after the information is converted. If the DSL has a speed of four (4) megabytes pre second for up and down data links, communication device 100X, in one embodiment, can divide the data band of the DSL to twenty-four (24) bi-directional trunks and other data pipes for transmitting voice and/or video information and other unregulated data traffics. Twenty-four bi-directional trunks, for example, can also be used for voice communications to replace 24 POTS lines (i.e. 24 analog trunks).

CO Exchange 800, in one embodiment, includes a POTS component 284, a DSL trunk interface 285, a DSL to voice adapter 286, and voice channels 287. CO Exchange 800, which may reside at a telephone company, is capable of connecting to various communications networks such as PSTN, Internet, WAN, and the like. POTS interface 284 receives and transmits analog voice signals between various systems such as PBX 700 and communication device 100X. Various links 281-283 are used to link POTS interface 284, DSL trunk 285, adapter 286, and voice channels 287. In one embodiment, adapter 286 is configured to divide data band of a DLS link into multiple trunks and other data paths for voice and data communications.

PBX 700, in one embodiment, includes a POTS interface 274 and voice channels 277. PBX 700 is capable of connecting to various local communication end units such as analog telephones and IP phones. For example, analog telephones can be connected to POTS trunk interface 274 via some POTS phone line interface on PBX 700 to one of the voice channels 277. Similarly, IP phones can be connected to one of the voice channels 277 through some IP interfaces on PBX 700. The network configuration illustrated in FIG. 9 can support multiple voice communications simultaneously using the high frequency band of a DSL. The multiple voice channels 2121 on a DSL line 2120 of communication device 10OX in one embodiment of the present invention thus emulate the multiple POTS lines 212 connected to CO 800 on PBX 700. The replacement from multiple POTS trunks 212 as used by PBX 700 to single wire of DSL embedded trunk 2120/2121, hence, eliminates the need of multiple POTS wires connected to CO 800.

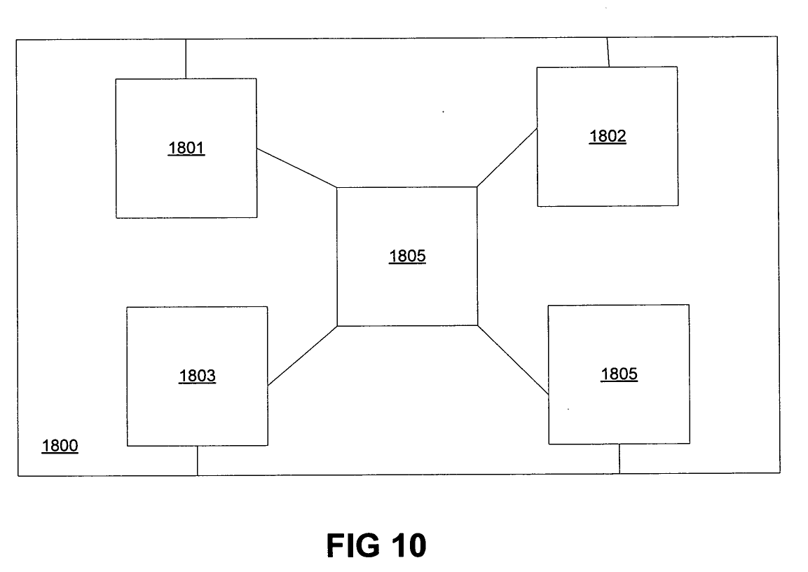

FIG. 10 is a block diagram illustrating a printed circuit board (“PCB”) 1800 having a communication device in accordance with one embodiment of the present invention. The components of network interface 1801, endpoint interface 1802, cluster interface 1803, service interface 1804, and control unit (“CU”) 1805 are physically mounted or placed on PCB 1800. CU 1805, in one embodiment, further includes a DSP for handling video packets. PCB 1800 further includes Wireless LAN component for transmitting/receiving data through a wireless network and a DSL modem for communicating with WAN, DSL, UART, USB, and the like. PCB 1800 may also include trunk handler for communicating with PSTN.

The present invention includes various processing steps, which will be described below. The steps of the present invention may be embodied in machine or computer executable instructions. The instructions can be used to cause a general purpose or special purpose system, which is programmed with the instructions to perform the steps of the present invention. Alternatively, the steps of the present invention may be performed by specific hardware components that contain hard-wired logic for performing the steps, or by any combination of programmed computer components and custom hardware components. While embodiments of the present invention will be described with reference to wireless communications network, the method and apparatus described herein is equally applicable to other network infrastructures or other data communications environments.

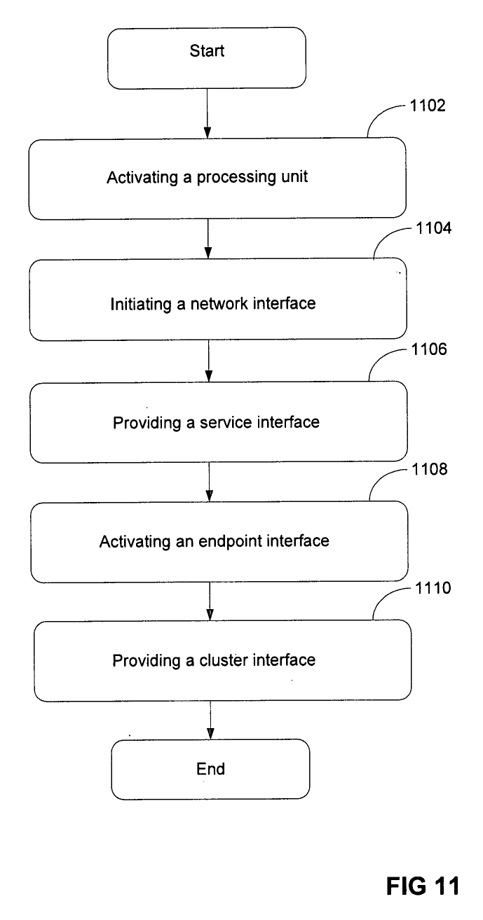

FIG. 11 is a flowchart illustrating a process of a communication device in accordance with one embodiment of the present invention. At block 1102, a process activates a processing unit (“PU”) in a single chassis for controlling various data flows in a communications network. To activate the PU, the process further enables a digital signal processing (“DSP”) for handling (or processing) video data signals. The process further facilitates the data flows between the network interface, the service interface, the endpoint interface, and the cluster interface. After block 1102, the process proceeds to the next block.

At block 1104, the process initiates a network interface in the single chassis to communicate with at least one communications network. For example, the communication between the network interface and the Internet is established. In another embodiment, the communication between the network interface and PSTN is established. After block 1104, the process moves to the next block.

At block 1106, the process provides a service interface in the single chassis to enhance service capabilities. To enhance the service capabilities, the process establishes channels to communicate with a plurality of surveillance devices. After block 1106, the process proceeds to the next block.

At block 1108, the process activates an endpoint interface in the single chassis to communicate with at least one local system. In one embodiment, the process is capable of communicating with computers, cellular phones, fax machines, or cameras. After block 1108, the process moves to the next block.

At block 1110, the process provides a cluster interface in the single chassis to enhance service capacity. The process uses the cluster interface to obtain and establish connections with other communication devices to expand system computing capacity. After this block, the process ends.

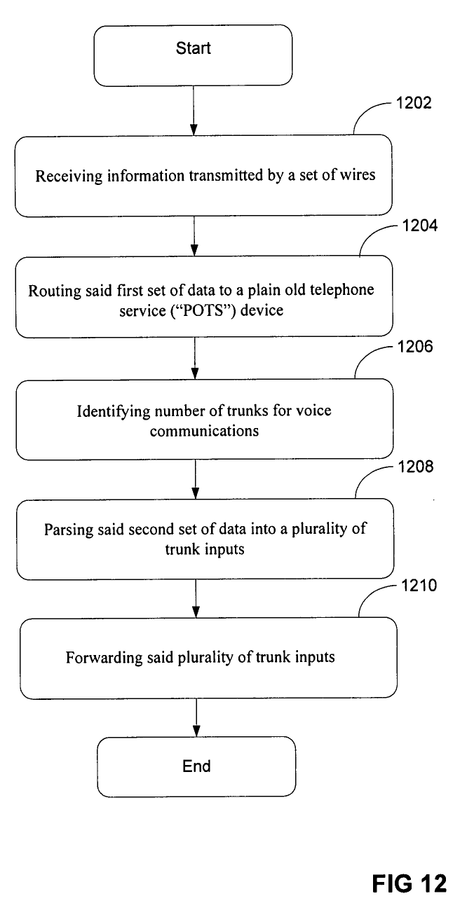

FIG. 12 is a flowchart illustrating a process of a communication device with PBX in accordance with one embodiment of the present invention. At block 1202, a process receives information transmitted by a set of wires utilizing a transmission protocol capable of transmitting a first set of data in low frequency (first band) and a second set of data in high frequency (second band). In one embodiment, the process establishes a communication with digital subscriber line (“DSL”), wherein the process receives voice information from a first band with low frequencies while the process also receives the second set of data from a second band with high frequencies. After this block, the process proceeds to the next block.

At block 1204, the process routes the first set of data to a plain old telephone service (“POTS”) device for voice communications. The process is further capable of communicating analog information to voice communication units. After block 1204, the process moves the next block.

At block 1206, the process identifies a number of trunks for voice communications in accordance with the transmission protocol. The transmission protocol is operated by a DSL provider. To identifying the number of trunks, the process identifies speed and capacity of the transmission protocol. In addition, the process sets the number of trunks in accordance with the speed and capacity of the transmission protocol. After block 1206, the process moves to the next block.

At block 1208, the process parses the second set of data into a plurality of trunk inputs in response to the number of trunks. The process uses each truck for a voice communication. After block 1208, the process moves to the next block.

At block 1210, the process forwards the plurality of trunk inputs to a plurality of voice communications devices. The process is also capable of receiving a plurality of trunk output from multiple voice communications units. Upon receipt of the trunk output, the process assembles trunk outputs into a second set of output data in response to the number of trunks. Upon receipt of a first set of output data from the POTS, the process places the first set of output data at a low frequency band of output transmission packets and places said second set of output data at a high frequency band of the output transmission packets. The process transmits said output transmission packets over the set of wires. After block 1210, the process ends.

While particular embodiments of the present invention have been shown and described, it will now be apparent to those skilled in the art having the benefit of this disclosure that many more modifications than mentioned above are possible without departing from the inventive concepts disclosed herein. Therefore, the appended claims are intended to encompass within their scope all such modifications as are within the spirit and scope of the present invention.

What is claimed is:

1. A communication device, comprising:
a processing unit configured to control data flow in said communication device;
a network interface coupled to said processing unit and configured to communicate to at least one communications network;
a service interface coupled to said processing unit and configured to enhance service capabilities;
an endpoint interface coupled to said processing unit and configured to communicate with one local system or end device; and
a cluster interface coupled to said processing unit and configured to enhance service capacity.

2. The device of claim 1, further comprising a single chassis configured to house said processing unit, said network interface, said service interface, said endpoint interface, and said cluster interface.

3. The device of claim 2, wherein said processing unit includes a digital signal processor (“DSP”) for video and voice signal processing.

4. The device of claim 2, wherein said processing unit configured to control data flow is further configured to facilitate said data flows between said network interface and said service interface.

5. The device of claim 5, wherein said processing unit configured to control data flow is further configured to facilitate said data flows between said endpoint interface and said cluster interface.

6. The device of claim 2, wherein a network interface coupled to said processing unit and configured to communicate to at least one communications network further includes coupling to one of an Internet, a local area network (“LAN”), a wide area network (“WAN”), and a public switched telephone network (“PSTN”).

7. The device of claim 6, wherein a service interface coupled to said processing unit and configured to enhance service capabilities further includes coupling to a memory device for storing video, voice, and data.

8. The device of claim 2, wherein said at least one local system is a wired system or a wireless system.

9. The device of claim 2, wherein said cluster interface is configured to facilitate a connection between a plurality of said communication devices.

10. The device of claim 1, further comprising a printed circuit board (“PCB”), wherein said PCB houses said processing unit, said network interface, said service interface, said endpoint interface, and said cluster interface.

11. A method of communications network from a single chassis comprising:
activating a processing unit in said single chassis to control various data flows in said communications network;
initiating a network interface in said single chassis to communicate with at least one communications network;
providing a service interface in said single chassis to enhance service capabilities;
activating an endpoint interface in said single chassis to communicate with at least one local system; and
providing a cluster interface in said single chassis to enhance service capacity.

12. The method of claims 11, wherein said activating a processing unit in said single chassis to control various data flows in said communications network further includes enabling a digital signal processing (“DSP”) for processing video data signals.

13. The method of claims 11, wherein said activating a processing unit in said single chassis to control various data flows in said communications network further includes facilitating said data flows between said network interface, said service interface, said endpoint interface, and said cluster interface.

14. The method of claims 11, wherein said initiating a network interface in said single chassis to communicate with at least one communications network further includes establishing communications with Internet.

15. The method of claims 11, wherein said providing a service interface in said single chassis to enhance service capabilities includes communicating with a plurality of surveillance devices for securities.

16. The method of claims 11, wherein said activating an endpoint interface in said single chassis to communicate with at least one local system includes communicating and monitoring computers, cellular phones, fax machines, or cameras.

17. The method of claims 11, wherein said providing a cluster interface in said single chassis to enhance service capacity includes establishing a connection with other communication devices for expanding computing capacity.

18. A method of communications network comprising:
receiving information transmitted by a set of wires utilizing a transmission protocol capable of transmitting a first set of data in low frequency and a second set of data in high frequency;
routing said first set of data to a plain old telephone service (“POTS”) device for voice communications;
identifying number of trunks for voice communications in accordance with said transmission protocol;
parsing said second set of data into a plurality of trunk inputs in response to said number of trunks; and
forwarding said plurality of trunk inputs to a plurality of voice communications units.

19. The method of claim 18, further comprising:
receiving a plurality of trunk output from said plurality of voice communications devices;
assembling said plurality of trunk output into a second set of output data in response to said number of trunks;
receiving a first set of output data from said POTS;
placing said first set of output data at a low frequency channel of output transmission packets and placing said second set of output data at a high frequency channel of said output transmission packets; and
transmitting said output transmission packets over said set of wires.

20. The method of claim 18, wherein said receiving information transmitted by a set of wires utilizing a transmission protocol capable of transmitting a first set of data in low frequency and a second set of data in high frequency further includes communicating with digital subscriber line (“DSL”).

21. The method of claim 20, wherein said communicating with digital subscriber line (“DSL”) includes:
receiving voice information from a first band with low frequencies; and
receiving said second set of data from a second band with high frequencies.

22. The method of claim 18, wherein said routing said first set of data to a plain old telephone service (“POTS”) device for voice communications includes communicating analog information to voice communication devices.

23. The method of claim 18, wherein said identifying number of trunks for voice communications further includes:
identifying speed and capacity of said transmission protocol; and
setting said number of trunks in accordance with said speed and capacity of said transmission protocol.

24. The method of claim 18, wherein said parsing said second set of data into a plurality of trunk inputs in response to said number of trunks further includes allocating each truck data set to a voice channel.

25. An apparatus for a communications network comprising:
means for receiving information transmitted by a set of wires utilizing a transmission protocol capable of transmitting a first set of data in low frequency and a second set of data in high frequency;
means for routing said first set of data to a plain old telephone service (“POTS”) device for voice communications;
means for identifying number of trunks for voice communications in accordance with said transmission protocol;
means for parsing said second set of data into a plurality of trunk inputs in response to said number of trunks; and
means for forwarding said plurality of trunk inputs to a plurality of voice communications units.

26. The apparatus of claim 25, further comprising:
means for receiving a plurality of trunk output from said plurality of voice communications devices;
means for assembling said plurality of trunk output into a second set of output data in response to said number of trunks;
means for receiving a first set of output data from said POTS;
means for placing said first set of output data at a low frequency channel of output transmission packets and placing said second set of output data at a high frequency channel of said output transmission packets; and
means for transmitting said output transmission packets over said set of wires.

27. The apparatus of claim 25, wherein said means for receiving information transmitted by a set of wires utilizing a transmission protocol capable of transmitting a first set of data in low frequency and a second set of data in high frequency further includes means for communicating with digital subscriber line (“DSL”).

28. The apparatus of claim 27, wherein said means for communicating with digital subscriber line (“DSL”) includes:
means for receiving voice information from a first band with low frequencies; and
means for receiving said second set of data from a second band with high frequencies.

29. The apparatus of claim 25, wherein said means for routing said first set of data to a plain old telephone service (“POTS”) device for voice communications includes means for communicating analog information to voice communication devices.

30. The apparatus of claim 25, wherein said means for identifying number of trunks for voice communications further includes:
means for identifying speed and capacity of said transmission protocol; and
means for setting said number of trunks in accordance with said speed and capacity of said transmission protocol.

31. The apparatus of claim 25, wherein said means for parsing said second set of data into a plurality of trunk inputs in response to said number of trunks further includes means for allocating each truck data set to a voice channel.
